(19) United States
(12) Patent Application Publication
(10) Pub. No.: US 2008/0198582 A1
(43) Pub. Date: Aug. 21, 2008

(54) Under-shelf light fixture

(75) Inventors: George C. Cox, Hamburg, PA (US); Bella Gutman, Morganville, NJ (US)

Correspondence Address: COHEN, PONTANI, LIEBERMAN & PAVANE LLP, 551 FIFTH AVENUE, SUITE 1210, NEW YORK, NY, 10176, US

(73) Assignee: Trinity, LLC

(21) Appl. No.: 12/072,027

(22) Filed: Feb. 21, 2008

Related U.S. Application Data
(60) Provisional application No. 60/902,699, filed on Feb. 21, 2007.

(51) Int. Cl. F21V 33/00; A47B 97/00

(52) U.S. Cl. 362/133

(57) ABSTRACT

A shelf assembly incorporating a light fixture includes a shelf having a top surface, a downward extending front skirt with an inward extending front lip, a pair of downward extending sidewalls, and possibly a rib extending parallel to the lip between the sidewalls. The light fixture includes an elongate box section with power cords at opposite ends and a pair of sockets for engaging the terminals of a light tube. A pair of brackets are fixed to the box section, each bracket having a front tab extending laterally of the box section for engaging the front lip of the shelf. The brackets are fixed in place using screws which engage the rib, if present, or the sidewalls. The box section contains a ballast and may have compartments which receive the power cords through friction fittings so that excess cord can be stored out of sight.

### RELATED APPLICATIONS

This application claims priority from U.S. Provisional Patent Application Ser. No. 60/902,699 which was filed on Feb. 21, 2007.

### BACKGROUND OF THE INVENTION

1. Field of the Invention

The invention relates to a light fixture for fixing under a shelf to illuminate articles displayed below the light fixture, which articles may be positioned on a lower shelf. The invention also relates to the combination of a light fixture and a shelf.

2. Discussion of Background Art

Light fixtures for illuminating articles displayed on shelves are well known. U.S. Pat. No. 5,690,415 (Krehl) discloses shelves having support brackets that clip into vertical tracks. A fluorescent light tube is fitted in a housing that is clipped to the front edge of each shelf. The tube is plugged into connectors on the brackets, which also contain the ballast, and are electrically connected to buses in the vertical tracks. Thus, the tracks not only support the shelves, but provide power to light the tube as soon as the brackets are clipped to the tracks.

U.S. Pat. No. 6,231,205 (Slesinger et al.) and U.S. Pat. No. 5,034,861 (Sklenak et al.) also disclose modular systems and under-shelf light fixtures, and supports which connect to conductors in vertical mounting tracks.

Each of the prior art systems discloses an integrated design, that is, a shelf which is specially designed to cooperate with a specially designed light fixture. The disclosed light fixtures cannot be readily adapted for fixing to other shelves, in particular shelves of standard design which are not designed especially to receive that light fixture.

A system which would readily adapt a light fixture for attaching to conventional shelves of different sizes would not only be more cost effective, but would offer more flexibility in providing illumination for the products being displayed.

### SUMMARY OF THE INVENTION

The light fixture according to the invention is particularly suited for retrofitting to an existing shelf, i.e. a specially designed shelf is not required. Since the light fixture does not extend below the front lip of the shelf, it does not interfere with storage space below the shelf, and is protected against damage.

The light fixture according to the invention holds well onto the shelving, and can be fitted to different standard size shelves.

The light fixture according to the invention is also easy to install by store associates and does not get in the way of perforations that are provided in the shelf.

A cord management system can be provided to allow installation on different depth shelves, while keeping excess power cord out of sight. Up to twelve or more light fixtures can be daisy-chained together by connecting the exposed lengths of cord on the undersides of the shelves.

According to a first embodiment, the light fixture is designed for fitting in an elongate gap between a lip along the front edge of the shelf, and a reinforcing rib parallel to the lip. The fixture has an elongate box section containing the ballast and having leads at opposite ends. A fluorescent tube lamp running parallel to the box section is plugged into sockets at opposite ends of the box section, and brackets are riveted to the box structure to retain the box structure in the gap. Each bracket has a horizontally extending tab that fits over the lip, and a hanging tab with a thumb screw for applying pressure to the rib.

The light fixture can be designed for any gap size, i.e., the dimension between the front lip and the rib, by simply changing the brackets. It can also be designed for any standard size fluorescent tube; 36″ and 48″ lengths are most common. Since the light fixture is not fixed to the sidewalls of the shelf, it can be considerably shorter than the shelf.

According to a second embodiment, the fluorescent tube running parallel to the box section is plugged into sockets near opposite ends of the box section. Here the box section (fixture housing) has two brackets that snap into a channel forming the front lip of the shelf; the box section is also held in place by brackets fixed to the ends of the box section, with attachment screws received in the brackets for engaging the sidewalls of the metal shelf. With this means of attachment, the perforations in the shelf are avoided, whereby the perforations can be used for the attachment of the many shelf management systems that are already in use in stores.

The box section (fixture housing) also includes a cord management system that permits the cords to be longer or shorter to accommodate different shelf depths. This is accomplished by storing unused lengths of electrical cord in cord compartments formed in opposite ends of the of the box section, the ballast being located between these compartments. Each compartment is provided with a friction fitting through which the cord passes. When the shelf is deeper, the cord can be pulled out of its compartment through the fitting. When the shelf is shallower, the cord can be pushed back into the compartment through the fitting.

The ability to have the cord used at different exposed lengths allows the under-shelf light fixture to be re-used when layout (planogram) changes are made. It can go from less deep to deeper shelves or vice versa as the store is remodeled or relocated.

The cords emerging from the compartments are clipped to respective sides of the shelf by plastic double-stick clips. Each cord extends from the light fixture to the back of the shelf, where it is connected under the shelf to a cord from an adjacent light fixture. By thus connecting the light fixtures in series, up to twelve light fixtures can be daisy-chained together to form a gondola run, the end fixture plugging into a power source at one end of the run.

It will be understood that the principles of the invention may be practiced with light fixtures designed for light sources other than fluorescent tubes, and power supplies other than ballasts. For example, the light fixture may hold a strip of LED's connected to a power supply in the form of a driver which converts 120V AC power to 12V DC power.

### BRIEF DESCRIPTION OF THE DRAWINGS

FIG. 1 is a perspective view of the underside of a shelf, showing the light fixture fixed to the shelf between the front lip and a rib;

FIG. 2 is an end view of the shelf, showing the light fixture in phantom, and a notch in the end bracket for receiving the cord;

FIG. 3 is a perspective view of the bracket in FIGS. 1 and 2;

FIG. 4 is a front perspective view of the topside of a metal retail shelf having apertures;

FIG. 5 is rear perspective view of the underside of the retail shelf of FIG. 4, showing the light fixture positioned for fixing to the shelf, and the cover positioned for fixing to the light fixture housing;

FIG. 6 is a front perspective view of the underside of the retail shelf of FIG. 4, showing the light fixture positioned for fixing to the shelf, and the cover positioned for fixing to the light fixture housing;

FIG. 7 is a front perspective view of the underside of the retail shelf of FIG. 4, showing the light fixture fixed to the shelf, and the cover fixed to the light fixture housing;

FIG. 8 is a plan view of the underside of the shelf showing the light fixture without the cover fixed to the light fixture housing;

FIG. 9 is a detail from FIG. 8, showing the storage space for unneeded length of power cord, and the friction fitting which receives the cord;

FIG. 10 is an exploded perspective of the shelf of FIG. 1 and an LED light fixture;

FIG. 11 is an end view of the shelf with an LED light fixture;

FIG. 12 is a perspective of the LED light fixture assembled to the shelf; and

FIG. 13 is a detailed view of the LED boards attached to the floor of the fixture.

### DETAILED DESCRIPTION OF THE PREFERRED EMBODIMENTS

FIGS. 1 and 2 show a first example of a metal shelf 10 assembled to a first example of a light fixture 20. The shelf 10 has many standard features including a top plate 11 provided with perforations 12 for attaching a shelf management program such as dividers, bins, and product identifiers. For structural strength, the shelf 10 is formed with a downward extending front skirt 13 having an inward extending lip 14, and a downward extending rear skirt 13′. For added strength, the shelf is also provided with downward extending ribs 15, 15′ which are preferably formed by bending the top plate 11 through two 90° bends separated by a 180° bend at the distal edge of the rib. The lateral sides of the shelf 10 are provided with downward extending sidewalls 16. The sidewalls 16 are each formed as angled plates which are welded to the underside of the top plate 11, and may also be welded to the front lip 14, the ribs 15, and a rear skirt 13′. Each sidewall 16 has a rear end provided with hooks 17 for engaging slots in an upright frame member fixed to a wall in known fashion. At least one clip 18 is provided for retaining a power cord, and a notch 19 is used for running the power cord through the side wall between the hooks 17. Variations in the above structure, such as forming the sidewalls by bending the top plate and welding on the ribs, will be apparent to one skilled in the art.

The light fixture 20 also has many standard features, but has been provided with brackets 30 for fitting the light fixture 20 to the underside of the shelf 10 in a recess bounded by the sidewalls 16, front skirt 13, and front rib 15. It is especially advantageous if the light fixture does not extend above this recess, so that it does not interfere with access to a lower shelf and is likewise protected from damage. The light fixture 20 includes a box section 21 having a front wall 22 and a cover 23 extending between opposed ends 24. The ends 24 receive respective electrical cords 26 connected to a power supply or ballast (not shown) inside the box section 21. A pair of sockets 28 extend from the front wall 22 adjacent to the opposed ends 24, and engage the terminals of a light tube 29, which typically contains a gas that is excited by the ballast and emits radiation that causes a coating inside the tube to fluoresce. The ballast and electrical connections can be accessed by removing the cover 23, which is formed as a shallow channel retained by screws.

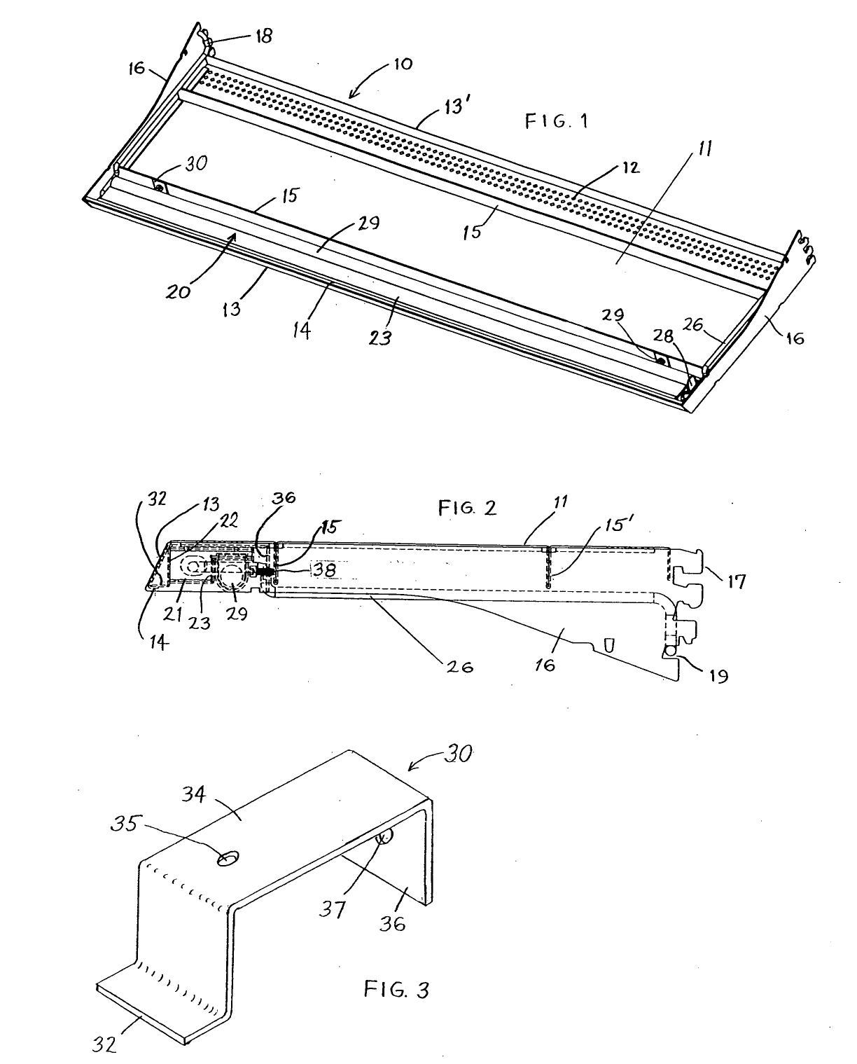

A bracket 30 is shown in detail in FIG. 3. Each bracket 30 is preferably a formed metal plate having a forward extending front tab 32 which engages the front lip 14, a span 34 which is riveted through hole 35 to the top of the box section 21, and a hanging rear tab 36 with a threaded hole 37 for receiving a screw 38. Instead of tapping the hole 37, a nut may be welded over it on the inside. The screw is preferably a thumb screw, so that the fixture may be assembled to the shelf without tools. This is accomplished by hooking the front tabs 32 over the front lip 14 of the shelf 10, and pushing the hanging rear tab 36 into position against the rib 14. As shown in FIGS. 1 and 2, the thumb screw 37 is then turned to tighten it against the rib 14.

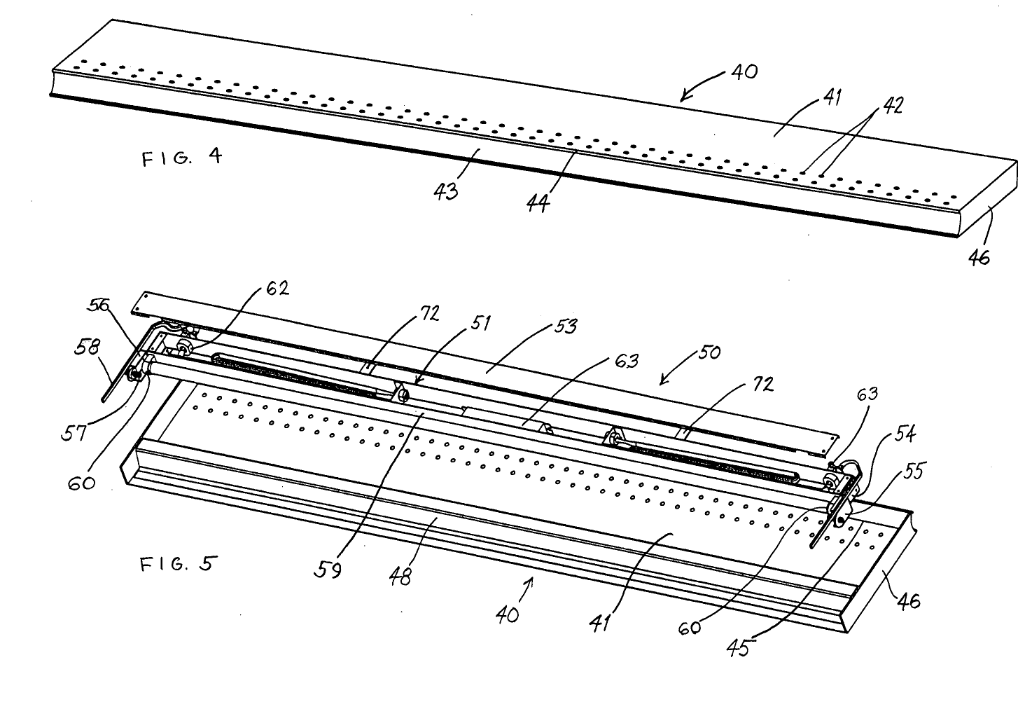

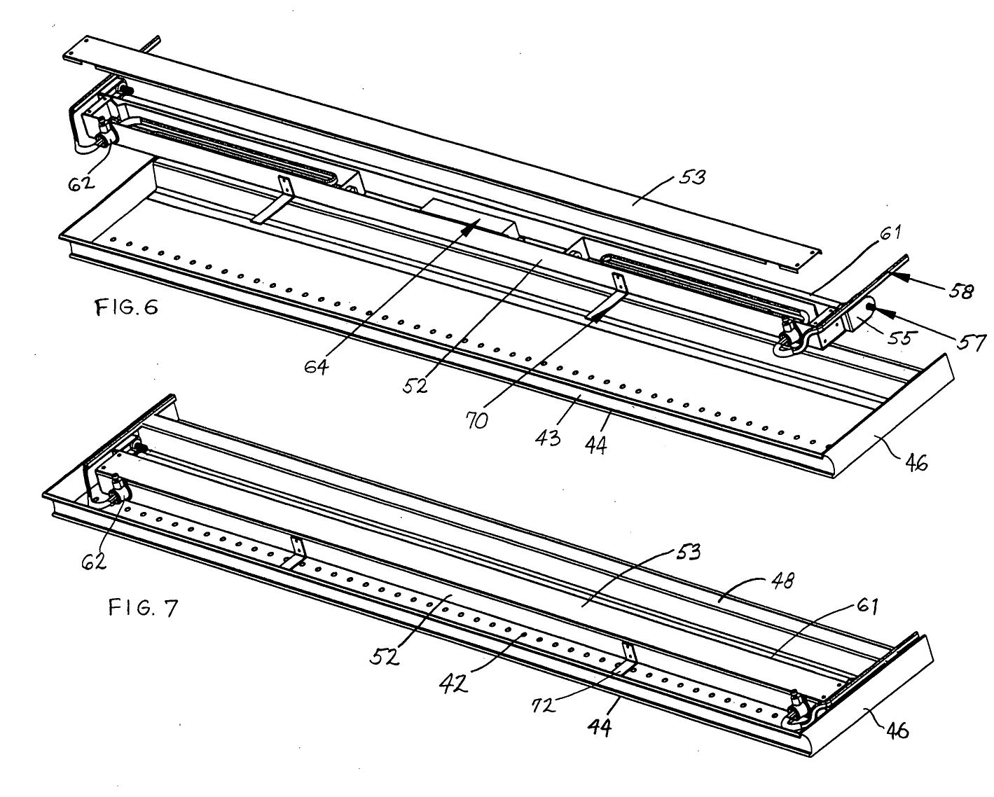

FIGS. 4-7 show an alternative metal shelf 40 including a top plate 41 with perforations 42 for mounting shelf management parts. The plate is bent in a series of steps in a brake or brakes to form a front skirt 43 with a reinforcing rib 44 and a pair of sidewalls 46, which are welded to the skirt 43 at the front corners. Seen from the inside, the reinforcing rib 44 appears as a channel having an inward extending front lip 45 facing the underside of the top plate 41. A rear box beam 48 is separately formed and welded to the underside of top plate 41 for strength.

The light fixture 50 includes a box section 51 having a front wall 52, a rear wall 59, and a cover 53 extending between opposed ends 54. An end bracket 55 riveted to each end 54 serves for attaching the fixture to respective shelf sidewalls 46; these end brackets 55 are each formed with a flange 56 and may have a threaded hole or a nut welded over a hole for receiving a retaining screw 57. The end brackets 55, like the brackets 30 and 70, are preferably a heavier gage than the sheet metal used to form the box sections 21 and 5′, typically 0.090″ vs. 0.030″ thick. As an alternative, a nut can be welded to each of the sidewalls or the sidewalls can be self-tapping. Electrical cords 58 are received in the front wall 52 adjacent to the ends 54 and connect to a ballast 64 inside the box section 51. A pair of sockets 60 extend from the rear wall 59 adjacent to the opposed ends 54, and engage the terminals of a light tube 61. As best seen in FIGS. 6 and 7, a pair of L-shaped brackets 70 having forward extending tabs 72 are riveted to the front wall 52 and engage the lip 45 formed inside the channel 44. When the front tabs 72 are resting on the lip 45, the end tabs 55 are screwed to the sidewalls 46 to fix the light fixture 50 under the shelf 40. Once again, it is preferred that the fixture not extend above the front skirt 43 or the sidewalls 46.

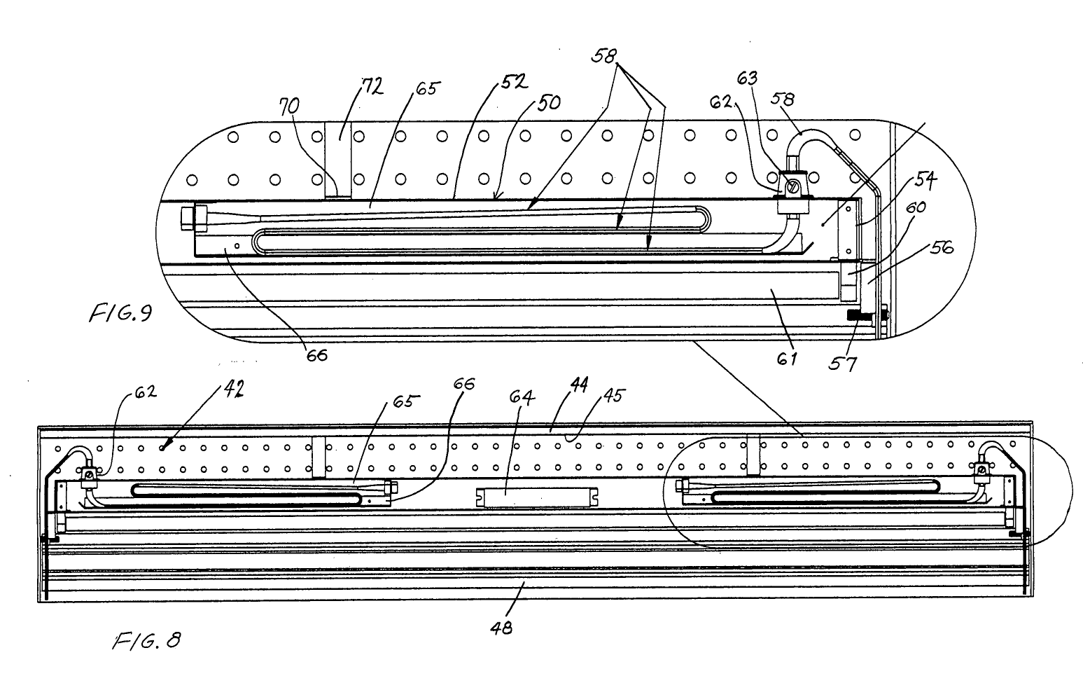

FIGS. 8 and 9 show the reception of the power cords 58 in the fixture 50 in greater detail. The box section 51 has a compartment 65 adjacent to each end 54, and a ballast 64 between the compartments 65. The box compartment 65 is preferably formed as an L-shaped plate 66 riveted to the floor of the box section; this plate is formed with an endwall through which the cord passes to the ballast 64. Each power cord 58 passes over a flange 56 and through a friction fitting 62 in the front wall 52 of the associated compartment 65. Each friction fitting is essentially a heavy-duty grommet, made of hard rubber or other high-friction elastomeric insulator having apertures receive the cords snugly so that they will remain in place when the cords are pushed through the fitting into the compartment. The fittings may also be provided with set screws 63 to ensure that the cords cannot be moved. This cord management system permits storing the cords out of sight, presenting a neat appearance and preventing their getting in the way.

The brackets 70 are preferably arranged to extend between perforations 42 in the top plate 41, so that dividers and other shelf management features can be freely mounted on the top surface.

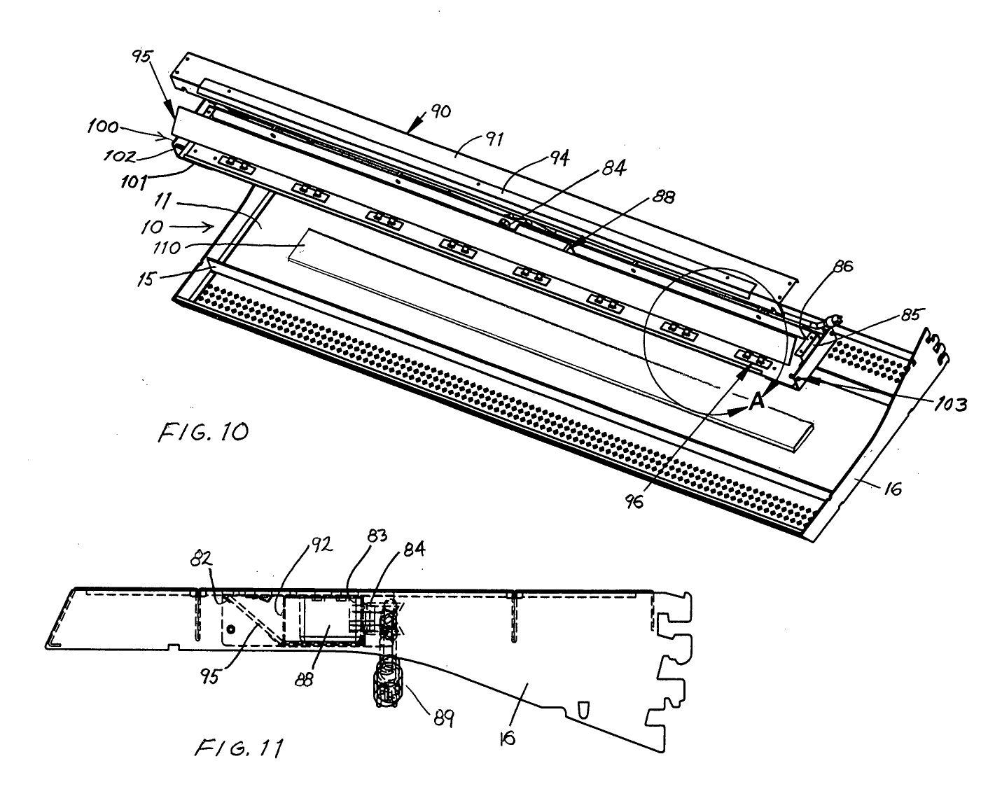

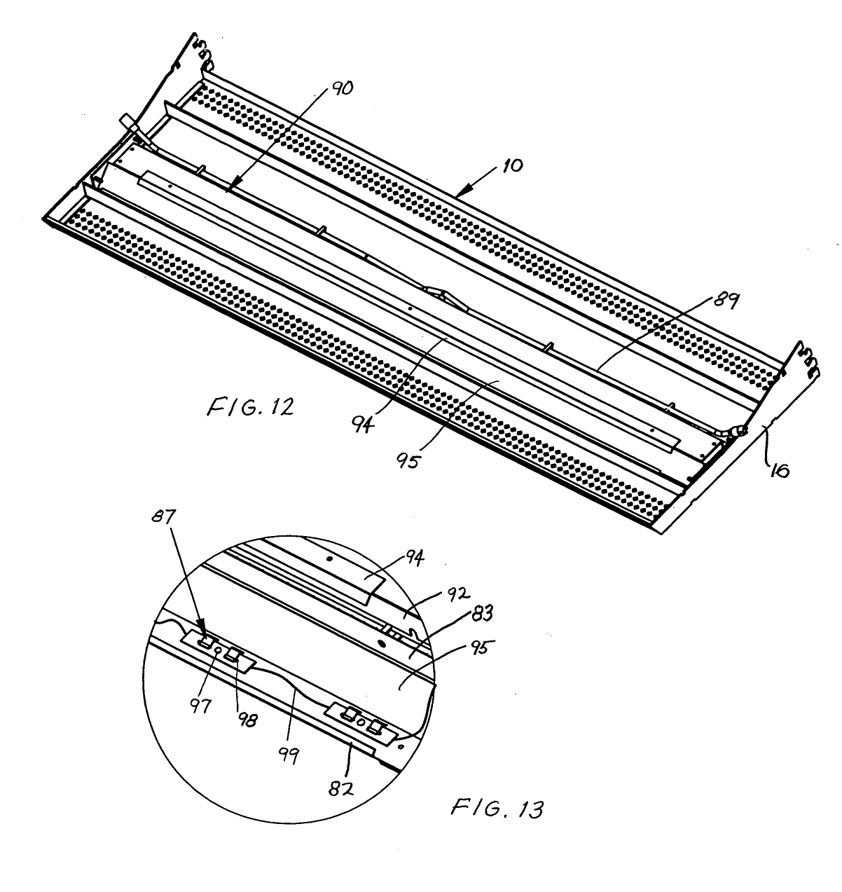

FIGS. 10-13 illustrate a third embodiment, wherein an LED light fixture 80 is fixed to the shelf 10, which has already been described in detail in conjunction with FIG. 1. The fixture 80 is formed of sheet steel (typically 0.030″ thick) and has a floor 81 formed with a front lip 82, a rear wall 83, and a pair of upright endwalls 85 provided with inward extending flanges 86 having holes for attaching a cover 90 with rivets or screws. The rear wall 83 is provided with a rubber fitting 84 which receives power cords 89 connected to a driver 88 for the LED's. Once again space is provided adjacent to the power supply for storing excess cord.

The cover 90 has a top portion 91 which is riveted to the flanges 86, and a front wall 92 which is formed at a right angle to the top portion 91. Riveted to the top portion 91 is a flap 94 formed with an obtuse angle so that a portion of the flap 94 forms an acute angle with the front wall 92. This makes it possible to slide the diffuser 95 into place between the front wall 92 and the front lip 82. The diffuser 95 is preferably a translucent plastic strip which diffuses light from the LED's.

As best seen in FIG. 10, a pair of L-shaped brackets 100 are fixed to respective ends of the fixture 80. Each bracket is L-shaped, with a floor portion 101 riveted to the floor 81 of the fixture 80, and an upright 102 adjacent to a respective endwall 85. The brackets 100, like the previously described brackets 30, 70, are heavier than the sheet metal of the fixture, typically about 0.090″ thick. The uprights 102 are provided with threaded holes 103, or alternatively may have nuts welded over the holes. The holes can therefore receive machine screws which are tightened against the sidewalls 16 of the shelf to secure the fixture to the shelf 10.

As shown most clearly in FIG. 13, the LED's 97 are provided on individual dielectric circuit boards 96 which are connected in series to adjacent boards by wires 99. Each board 96 has a pair of slots 96 which are engaged by spring tabs 87 formed in the floor 81 of the fixture 80. The boards are therefore easily assembled to the fixture by snapping into place under the tabs 18.

Prior to securing the fixture 80 to the sidewalls 16 of the shelf 10, the fixture 80 is conveniently positioned by using two-sided tape 110 which may be first adhered to either the shelf 10 or the floor 81 of the fixture. It is also possible to engage the fixture to the front lip 14 of the shelf 10 using a bracket formed with two right angles into a Z-profile, wherein the top portion can be riveted to the floor of the fixture on the side which faces the shelf, and the bottom portion passes over the rib 15 and traverses the space between the rib 15 and the front skirt 13. This leaves the holes 12 free for fixing shelf management features.

The foregoing is exemplary and not intended to limit the scope of the claims which follow.

What is claimed is:

1. A light fixture for mounting to the underside of a shelf having a top surface, a downward extending front skirt, possibly with an inward extending front lip, a pair of downward extending sidewalls, and possibly a rib extending parallel to said lip between said sidewalls, the light fixture comprising:
an elongate box section having opposite ends, the box section containing a power supply for a light source and receiving a pair of power cords; and
at least one bracket fixed to said box section, said bracket having means for engaging at least one of said front lip and said sidewalls.

2. The light fixture of claim 1 wherein said at least one bracket comprises a front tab extending laterally of said box section for engaging the front lip.

3. The light fixture of claim 2 comprising a pair of said brackets.

4. The light fixture of claim 2 each said bracket has a hanging tab opposite from said front tab, said hanging tab being spaced from said front tab to accommodate said box section and said light tube between said front tab and said hanging tab, wherein said hanging tab can be fixed to said rib.

5. The light fixture of claim 4 wherein each said hanging tab has a threaded hole for receiving a screw, whereby said screw can be tightened against said rib to fix said box section between said rib and said front lip

6. The light fixture of claim 2 further comprising a pair of end brackets fixed to respective said opposite ends of said box section, wherein said end brackets can be fixed to respective said sidewalls of said shelf.

7. The light fixture of claim 1 wherein said at least one bracket comprises a pair of end brackets fixed to respective said opposite ends of said box section, wherein said end brackets can be fixed to respective said sidewalls of said shelf.

8. The light fixture of claim 7 wherein each said end bracket has at least one hole with a screw received therein for tightening against a respective said sidewall of said shelf to fix said box section between said side walls.

9. The light fixture of claim 1 wherein said box section has at least one compartment where excess cord can be stored.

10. The light fixture of claim 9 further comprising at least one friction fitting through which a respective said cord enters a respective said compartment in a friction fit, whereby said cord can be pushed into and pulled out of said compartment.

11. The light fixture of claim 9 wherein said box section comprises a pair of said compartments adjacent to respective said opposite ends, said power supply being located between said compartments.

12. The light fixture of claim 1 wherein the light source is a light tube having terminals, and the power supply is a ballast, the fixture further comprising a pair of sockets for engaging the terminals of the light tube, said sockets being fixed to said box section adjacent to respective said opposite ends.

13. A shelf assembly incorporating a light fixture, the assembly comprising:
a shelf having a top surface, a downward extending front skirt, and a pair of downward extending sidewalls; and
a light fixture comprising an elongate box section having opposite ends, said box section containing a power supply for a light source and receiving a pair of power cords; and
at least one bracket fixed to said box section, said bracket having means for engaging at least one of said front lip and said sidewalls.

14. The assembly of claim 1 wherein said downward extending front skirt has an inward extending front lip, and said at least one bracket comprises a front tab extending laterally of said box section for engaging the front lip.

15. The assembly of claim 14 comprising a pair of said brackets.

16. The assembly of claim 14 wherein the shelf further comprises a rib extending parallel to said front lip between said side walls, each said bracket having a hanging tab opposite from said front tab, said hanging tab being spaced from said front tab to accommodate said box section and said light tube between said front tab and said hanging tab, wherein said hanging tab can be fixed to said rib to fix said box section between said rib and said front lip.

17. The assembly of claim 16 wherein each said hanging tab has a threaded hole with a screw received therein for tightening against said rib to fix said box section between said rib and said front lip.

18. The assembly of claim 14 further comprising a pair of end brackets fixed to respective said opposite ends of said box section, wherein said end brackets can be fixed to respective said side walls of said shelf.

19. The assembly of claim 13 wherein said at least one bracket comprises a pair of end brackets fixed to respective said opposite ends of said box section, wherein said end brackets can be fixed to respective said sidewalls of said shelf.

20. The assembly of claim 19 wherein each said end bracket has at least one hole with a screw received therein for tightening against a respective said sidewall of said shelf to fix said box section between said side walls.

21. The assembly of claim 11 wherein said box section has at least one compartment wherein excess cord can be stored.

22. The assembly of claim 21 further comprising at least one friction fitting through which a respective said power cord enters a respective said compartment in a friction fit, whereby said cord can be pushed into and pulled out of said compartment.

23. The assembly of claim 21 wherein said box section comprises a pair of said compartments adjacent to respective said opposite ends, said ballast being located between said compartments.

24. The assembly of claim 13 wherein the light source is a light tube having terminals, and the power supply is a ballast, the light fixture further comprising a pair of sockets for engaging the terminals of the light tube, said sockets being fixed to said box section adjacent to respective said opposite ends.
